(19) United States
(12) Patent Application Publication
(10) Pub. No.: US 2007/0223378 A1
(43) Pub. Date: Sep. 27, 2007

(54) Internet traffic controller, internet-traffic controlling system, and internet-traffic controlling method

(75) Inventors: Yasuo Take, Kawasaki (JP); Kazuo Mizuta, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/491,702

(22) Filed: Jul. 24, 2006

(30) Foreign Application Priority Data
Mar. 23, 2006 (JP) 2006-081077

(51) Int. Cl. H04J 1/16

(52) U.S. Cl. 370/235

(57) ABSTRACT

An internet traffic controller controls internet traffic in an internet protocol network through which packets are distributed for telephone calls between a first communication device and a second communication device. The internet traffic controller acquires call control packets and call packets flowing on a transmission line between the first communication device and the second communication device, determines whether the transmission line is congested based on the acquired packets, and instructs to regulate call connections in the transmission line when the transmission line is determined to be congested.

### BACKGROUND OF THE INVENTION

1. Field of the Invention

The present invention generally relates to internet protocol networks, and more specifically relates to preventing congestion of telephone calls on the internet protocol networks.

2. Description of the Related Art

Internet protocol (IP) telephone systems route telephone calls over IP networks such as the Internet. Such IP telephone systems generally control call connections between communication devices (for example, telephone sets) using a communication controlling protocol called session initiation protocol (SIP).

Most of the IP networks include a huge number of relay units, communication devices, and transmission lines that link the units and the devices. To prevent congestion of an IP network, one approach is to monitor internet traffic over each transmission line and control call connections so that the internet traffic does not exceed an acceptable amount.

Various methods are known for controlling the call connections. For example, Japanese Patent Publication No. 2004-88666 discloses estimating the number of connected calls and controlling the number of calls based on a call density, which is the number of the calls per unit time. The number of connected calls is estimated by monitoring SIP messages compliant with the SIP. However, the number of connected calls is only estimation so that sometimes it can deviate greatly from the actual number of the call connections. It is not rare to lose SIP messages on the network. For example, if an SIP message to inform termination of an SIP session is lost, a system according to the technology misunderstands that the call is still connected, though the call connection has been actually terminated.

Various packets flow in IP networks. For example, call control packets are used to control calls, call packets contain information about the contents of a telephone call, and general packets contain information about electronic mails, web access or the like. The SIP messages are contained only in the control packets so that accurate control cannot be performed by monitoring only the SIP messages. This is because the congestion in the transmission line also depends on the amount of the call packets and general packets.

Thus, there is a need of a technology capable of accurately detecting congestion of telephone calls in IP networks.

### SUMMARY OF THE INVENTION

It is an object of the present invention to at least partially solve the problems in the conventional technology.

According to an aspect of the present invention, an internet traffic controller that controls internet traffic in an internet protocol network through which packets are distributed for telephone calls between a first communication device and a second communication device includes a packet acquiring unit that acquires call control packets and call packets flowing on a transmission line between the first communication device and the second communication device on the internet protocol network; a congestion determining unit that determines whether the transmission line is congested based on the call control packets and the call packets acquired by the packet acquiring unit; and an instructing unit that instructs regulation of call connections over the transmission line when the congestion determining unit determines that the transmission line is congested.

According to another aspect of the present invention, an internet-traffic controlling system that controls internet traffic in an internet protocol network through which packets are distributed for telephone calls between a first communication device and a second communication device includes a packet acquiring unit that acquires call control packets and call packets flowing on a transmission line between the first communication device and the second communication device on the internet protocol network; a congestion determining unit that determines whether the transmission line is congested based on the call control packets and the call packets acquired by the packet acquiring unit; and an instructing unit that instructs regulation of call connections over the transmission line when the congestion determining unit determines that the transmission line is congested.

According to still another aspect of the present invention, an internet-traffic controlling method of controlling internet traffic in an internet protocol network through which packets are distributed for telephone calls between a first communication device and a second communication device includes acquiring call control packets and call packets flowing on a transmission line between the first communication device and the second communication device on the internet protocol network; determining whether the transmission line is congested based on the call control packets and the call packets acquired at the acquiring; and instructing regulation of call connections over the transmission line upon it is determined at the determining that the transmission line is congested.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an outline of an internet-traffic controlling technique according to a first embodiment of the present invention;

FIG. 2 is a detailed block diagram of the internet traffic controller shown in FIG. 1;

FIG. 3 is an example of the contents of call managing information;

FIG. 4 is an example of the contents of threshold managing information;

FIG. 5 is an example of the contents of general packet information;

FIG. 6 is a flowchart for explaining a process performed by the internet traffic controller shown in FIG. 2;

FIG. 7A is an example of a list of communication devices;

FIG. 7B is another example of the list of communication devices;

FIG. 8 is an example of a situation where a call is made;

FIG. 9 is a sequence diagram for explaining a process under the condition of the call shown in FIG. 8;

FIG. 10 is a sequence diagram for explaining a process based on priority;

FIG. 11 is a block diagram of an internet traffic controller according to a second embodiment of the present invention;

FIG. 12 is a flowchart for explaining a process performed by the internet traffic controller shown in FIG. 12;

FIG. 13A is a schematic for explaining a process of establishing an SIP session; and

FIG. 13B is a schematic for explaining a process of terminating the SIP session.

### DETAILED DESCRIPTION OF THE PREFERRED EMBODIMENTS

Exemplary embodiments of the present invention will be explained below in detail while referring to the accompanying drawings. The explanation is based on a case that the internet-traffic controlling technique is applied to an internet traffic controller connected to a network such as an IP network.

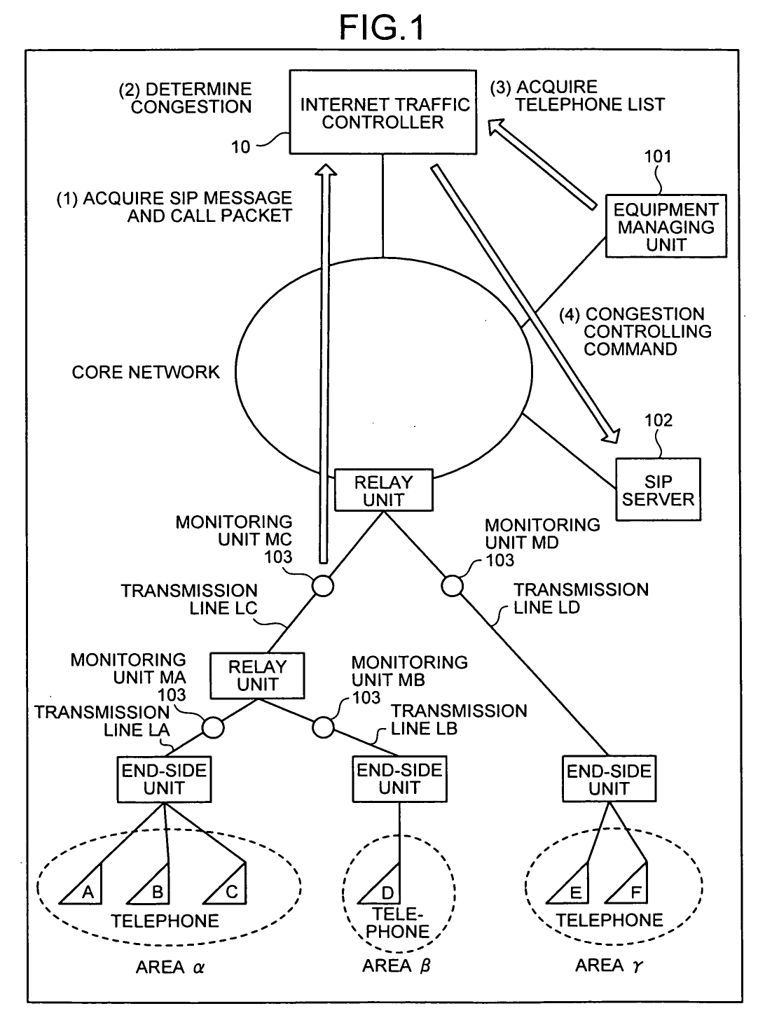

FIG. 1 is a schematic for explaining an outline of an internet-traffic controlling technique according to a first embodiment of the present invention. An IP network to which the internet-traffic controlling technique can be applied includes an internet traffic controller 10, an equipment managing unit 101, and an SIP server 102 all connected to a core network. A relay unit is provided in the core network, and other relay units and end-side units are connected hierarchically to that relay unit. The relay units are connected to each other and the relay units are connected to the end-side units with transmission lines LA to LD. Monitoring units 103, MA to MD, are provided on the transmission lines. Further, at least one telephone, for example, an IP telephone, is connected to each end-side unit. Hereinafter, a telephone or a group of telephones that is connected to an end-side unit is referred to as an area. FIG. 1 includes three areas: α, β, and γ.

The equipment managing unit 101 manages communication devices (herein, telephones) that belongs to each transmission line, and the SIP server 102 manages telephone calls using the SIP. The relay unit can be a gateway, a router or the like that relays and routes communication data, and the end-side unit can be an asymmetric digital subscriber line (ADSL) model, an ADSL router, an IP gateway, or the like.

Each of the monitoring units 103 monitors SIP messages (hereinafter, “call control packets”) and call packets distributed through a corresponding one of the transmission lines, and sends the acquired packets to the internet traffic controller 10 occasionally (see (1) in FIG. 1). The internet traffic controller 10 determines whether a transmission line is congested based on call control packets and call packets received from a monitoring unit on that transmission line (see (2) in FIG. 1).

Subsequently, the internet traffic controller 10 acquires a list of telephones (a telephone list) that belongs to the transmission line that was determined to be congested from the equipment managing unit 101 (see (3) in FIG. 1), and determines the telephone that needs to be subjected to communication regulation and transmits a congestion-controlling command to that effect to the SIP server 102 (see (4) in FIG. 1). The SIP server 102 executes the communication regulation against the designated telephone.

As described above, whether a transmission line is congested is determined based on call packets and call control packets flowing in that transmission line. This can solve the problem with the conventional technology that the estimated number of the calls deviates from the actual number of the calls.

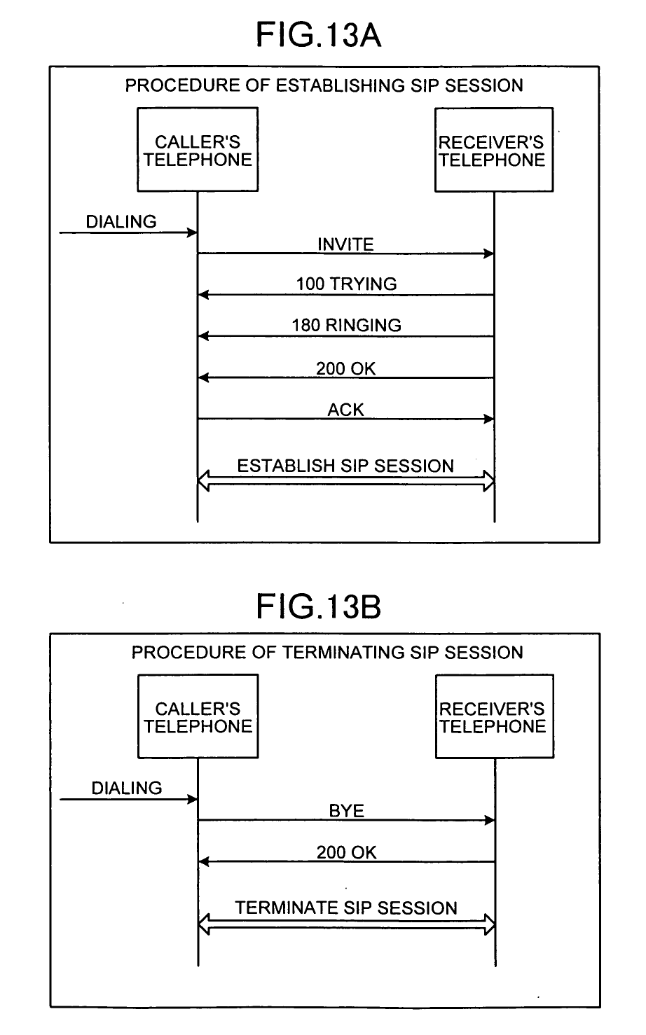

FIG. 13A is a schematic for explaining a process of establishing an SIP session, and FIG. 13B is a schematic for explaining a process of terminating the SIP session. The processes of establishing and terminating the SIP session based on the SIP message is explained with reference to FIGS. 13A and 13B for better understanding of the problems in the conventional technology.

As shown in FIG. 13A, in the process of establishing the SIP session, as a result of dial control on a caller's telephone, an invite message is transmitted to a receiver's telephone. Upon receiving the invite message, the receiver's telephone transmits, to the caller's telephone, a trying message indicating that the process is under way, a ringing message indicating that the receiver's telephone is ringing, and an OK message indicating that the receiver's telephone is ready to receive the call. The caller's telephone then sends an acknowledgement (ACK) message in response to the OK message to the receiver's telephone whereby an SIP session is established and bidirectional communication is started.

As shown in FIG. 13B, when the caller hangs up the telephone, the caller's telephone transmits a bye message to the receiver's telephone. The receiver's telephone sends an OK message to the caller's telephone in response to the bye message thereby terminating the SIP session.

Because the SIP session is established and terminated based on the procedures shown in FIGS. 13A and 13B, it is possible to compute the number of the established calls by counting up the number of the calls upon confirmation of the invite message and subtracting the number upon confirmation of the bye message. However, if the bye message is lost on the network or monitoring the bye massage fails, the number of terminated calls can not be estimated accurately so that the estimated number of the calls deviates from the actual number of the calls.

According to a first embodiment of the present invention, estimation is made based on both the call packets and the call control packets. When no call packets flow in a transmission line after the caller's telephone has sent an invite message to a receiver's telephone, it is determined that the call is terminated. As a result, the number of established calls can be estimated accurately.

The internet traffic controller 10 determines the congested condition with respect to each transmission line, and therefore the internet traffic controller 10 can send a command to each group of the telephones belonging to the same transmission line to avoid the congestion. Furthermore, the internet traffic controller 10 can also acquire the congested condition by transmitting a test packet to a transmission line of which the congested condition is not clear (not shown in FIG. 1), or acquire general packets in the transmission line (not shown in FIG. 1). These functions will be detailed later.

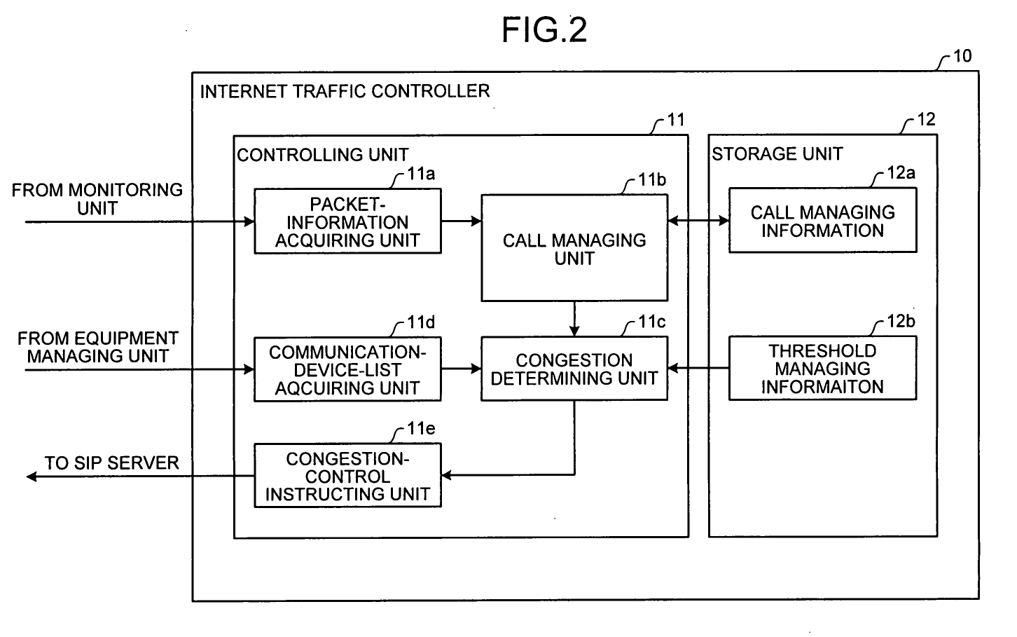

FIG. 2 is a detailed block diagram of the internet traffic controller 10. The internet traffic controller 10 includes a controlling unit 11 and a storage unit 12. The controlling unit 11 further includes a packet-information acquiring unit 11a, a call managing unit 11b, a congestion determining unit 11c, a communication-device-list acquiring unit 11d, and a congestion-control instructing unit 11e. The storage unit 12 stores therein a call managing information 12a and a threshold managing information 12b.

The controlling unit 11 acquires the call control packets, the call packets, and the general packets from the monitoring unit 103 provided on each transmission line; estimates the number of the connected calls and the bandwidth from the packets; determines the congested condition of each transmission line using a predetermined threshold; and provides a control to regulate calls to the telephones belonging to the transmission line.

The packet-information acquiring unit 11a receives the call control packets and the call packets from the monitoring unit 103 and transfers the packets to the call managing unit 11b. The packet-information acquiring unit 11a can also receive general packets from the monitoring unit 103 and transfer the packets to the call managing unit 11b. It is assumed here that the packet-information acquiring unit 11a receives the packets from each monitoring unit 103; however, the packet-information acquiring unit 11a can be configured to receive packet information that includes caller's addresses and receiver's addresses extracted from the packets in each transmission line, from the monitoring unit 103.

The call managing unit 11b associates each of the call control packets with the corresponding call packet received from the packet-information acquiring unit 11a before updating the call managing information 12a that indicates information on the established call. The call managing unit 11b also commands the congestion determining unit 11c to determine the congested condition of each transmission line.

The congestion determining unit 11c determines the congested condition of each transmission line based on the threshold managing information 12b in the storage unit 12. The congestion determining unit 11c also transfers a communication-device list received from the equipment managing unit 101 via the communication-device-list acquiring unit 11d and the determination of the congestion to the congestion-control instructing unit 11e.

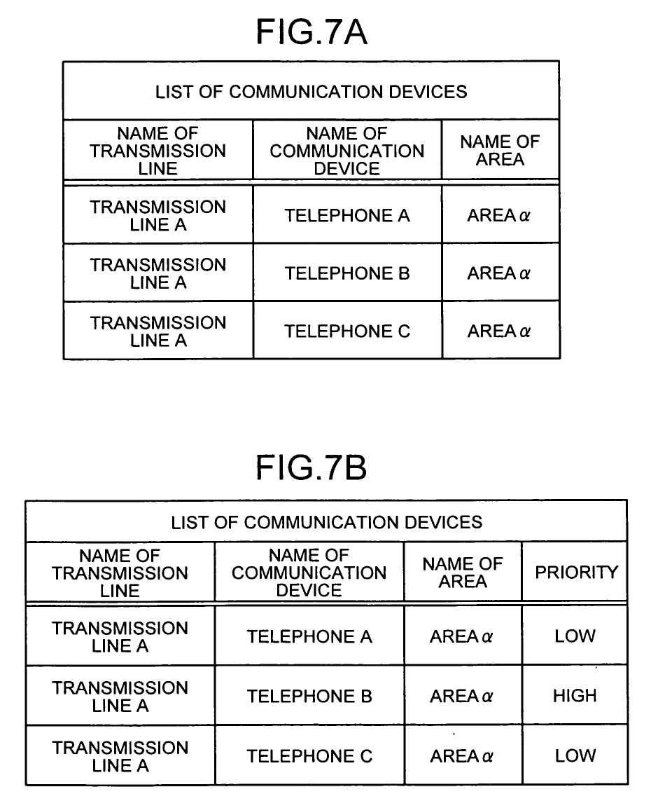

The congestion-control instructing unit 11e receives the communication-device list that enlists communication devices belonging to each transmission line from the equipment managing unit 101, and transfers the communication-device list to the congestion determining unit 11c. It is assumed here that the communication-device-list acquiring unit 11d receives the communication-device list from the equipment managing unit 101; however, the communication-device-list acquiring unit 11d can be configured to send a request for the communication-device list for a specific transmission line to the equipment managing unit 101 to receive the communication-device list in response to the request. The communication-device list will be detailed later with reference to FIGS. 7A and 7B.

The congestion-control instructing unit 11e determines the communication device that requires the communication regulation based on the determination of congestion received from the congestion determining unit 11c, and then commands the SIP server 102 to implement the communication regulation to the determined communication device.

The storage unit 12 includes a storage device such as a nonvolatile random access memory (RAM) and a hard disk drive, which stores therein the call managing information 12a that indicates information on each call (namely, each of the established calls) and the threshold managing information 12b used as a criterion for the determination.

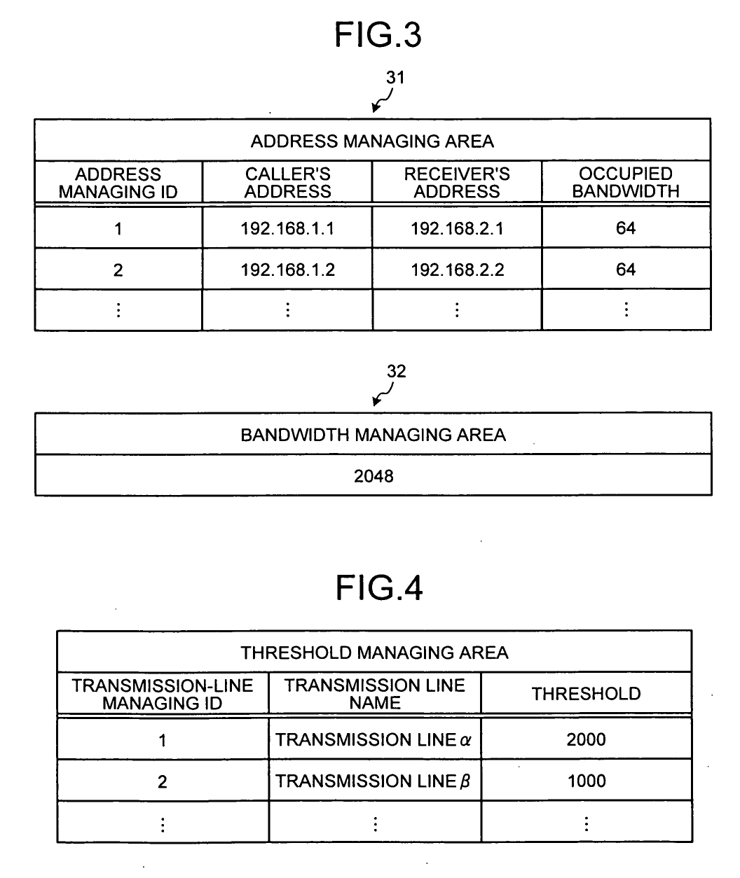

FIG. 3 is an example of the contents of the call managing information 12a. The call managing information 12a includes an address managing area (see 31 in FIG. 3) and a bandwidth managing area (see 32 in FIG. 3). The call managing information 12a is managed with respect to each transmission line. Namely, when there are 1,000 transmission lines to be managed, 1,000 sets of the address managing area and bandwidth managing area are prepared.

The address managing area stores therein a caller's address, a receiver's address, and an occupied bandwidth for each call. An address-managing ID is used to uniquely identify each of the records stored in the address managing area. The occupied bandwidth indicates a value of the occupied bandwidth based on the type of COder DECoder (CODEC). The CODEC type can be G.711, G.729a, and the like. The bandwidth managing area is the sum of the occupied bandwidth values shown in the address managing area, indicating the current value of the occupied bandwidth for each transmission line.

FIG. 4 is an example of the contents of threshold managing information. The threshold managing information 12b includes the maximum values of the bandwidth with respect to each transmission line to be managed. Concretely, the threshold managing information 12b includes a transmission-line managing ID, a transmission line name, and a threshold. The transmission-line managing ID is used to uniquely identify each transmission line, the transmission line name indicates a name of each transmission line, and the threshold is the maximum bandwidth with respect to each transmission line.

The storage unit 12 can store therein managing information other than the call managing information 12a and the threshold managing information 12b. For example, the storage unit 12 can also store general packet information on the general packet that the packet-information acquiring unit 11a acquired from each of the monitoring units 103 in a general-packet managing area provided at the storage unit 12.

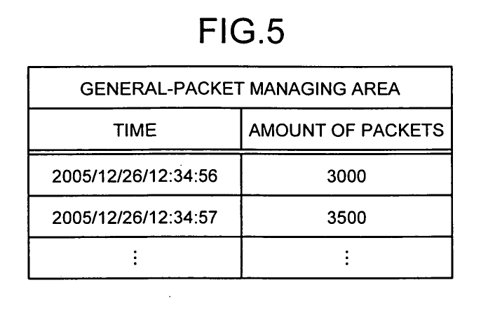

FIG. 5 is an example of the contents of the general packet information. The general-packet managing area includes information on time that indicates the time at which the general packet is acquired and the amount of packets that indicates the amount of the general packets. The general packet managing area stores therein the transition of the amount of the packets at each time period, and the general packet information in the general-packet managing area is used when the congestion determining unit 11c determines the congestion at each transmission line. For example, when the maximum bandwidth for a specific transmission line is 2,000, the congestion determining unit 11c determines that there is no congestion if the occupied bandwidth of the call packets is 1,000 and that of the general packets is null; however, the congestion determining unit 11c determines that there is congestion if the occupied bandwidth of the normal packets is also 1,000.

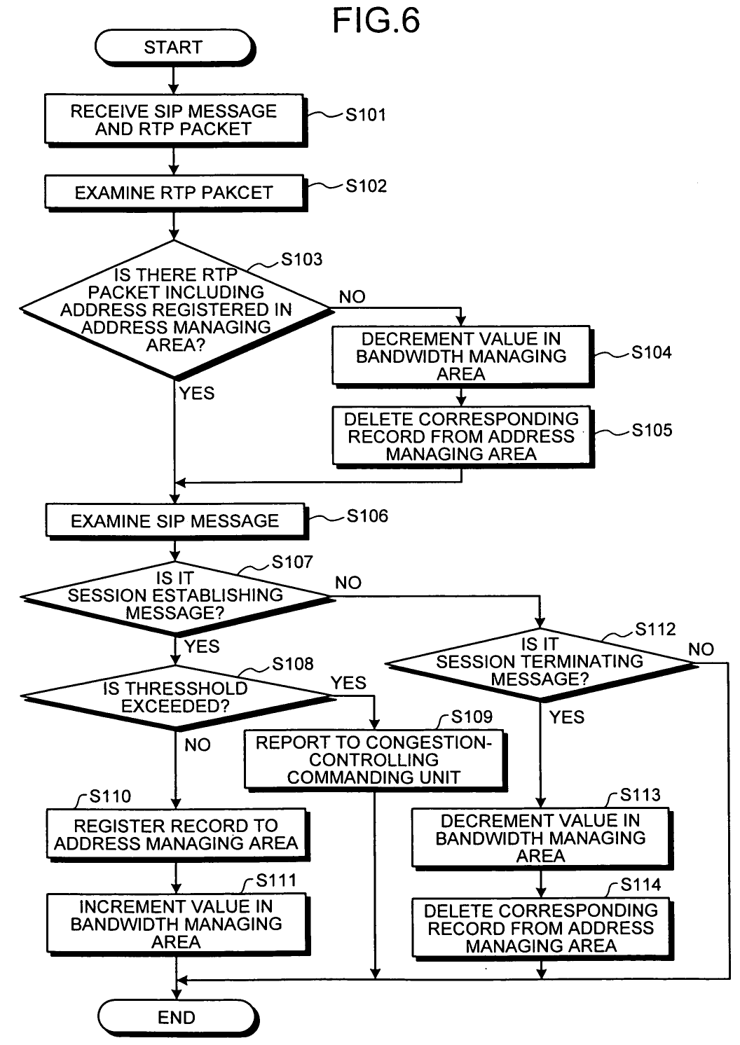

FIG. 6 is a flowchart for explaining a process performed by the internet traffic controller 10. When the call managing unit 11b receives an SIP message and a real-time transport protocol (RTP) packet (call packet) from the packet-information acquiring unit 11a (step S101), the call managing unit 11b first examines the RTP packet (step S102).

The call managing unit 11b determines whether there is an RTP packet that includes an address that has been registered in the address managing area (step S103). When there is no such RTP packet (NO at step S103), the call managing unit 11b decrements by one the value stored in the bandwidth managing area 32 assuming that the call has been terminated (step S104) and deletes the corresponding record from the address managing area (step S105).

On the other hand, when there is an RTP packet that includes an address that has been registered in the address managing area (YES at step S103), the call managing unit 11b examines an SIP message (step S106). In this manner, because the record that remains in the address managing area even after termination of a call is deleted based on the presence of the RTP packet, it is possible to accurately manage the occupied bandwidth (current value) on each transmission line.

The steps S106 and after indicate how to manage the call based on the SIP message. The call managing unit 11b examines the SIP message (step S106), and determines whether the SIP message is a session establishing message (step S107). When the SIP message is a session establishing message (YES at step S107), the call managing unit 11b subsequently determines whether the total bandwidth would exceed the threshold (see FIG. 4) if the establishment of the session is allowed (step S108).

If it is determined that the total bandwidth would exceed the threshold (YES at step S108), the call managing unit 11b reports the result to the congestion-control instructing unit 11e (step S109). Upon receiving the report, the congestion-control instructing unit 11e commands the SIP server to prevent the congestion.

On the other hand, if it is determined that the total bandwidth would not exceed the threshold (NO at step S108), the call managing unit 11b registers a new record to the address managing area (step S110), increments the value in the bandwidth managing area (step S111) and terminates the process.

When the call managing unit 11b determines that the SIP message is not the session establishing message (NO at step S107), the call managing unit 11b subsequently determines whether the message is a session terminating message (step S112). If the message is a session terminating message (YES at step S112), the call managing unit 11b decrements the value in the bandwidth managing area (step S113), deletes the corresponding record from the address managing area (step S114), and terminates the process. If it is determined at step S112 that the message is not a session terminating message (NO at step S112), the process is terminated straight.

FIGS. 7A and 7B are examples of a list of communication devices that the communication-device-list acquiring unit 11d acquires from the equipment managing unit 101. FIG. 7A is a basic example of the list, and FIG. 7B is another example of the list including the priority of the call.

The list shown in FIG. 7A includes the name of the transmission line that identifies the transmission line, the name of the communication device that identifies the communication devices belonging to the transmission line, and the name of the area that identifies the area to which the communication devices belongs. The list in FIG. 7B further includes the priority. For example, the priority of the telephone B is higher than that of the telephones A and C.

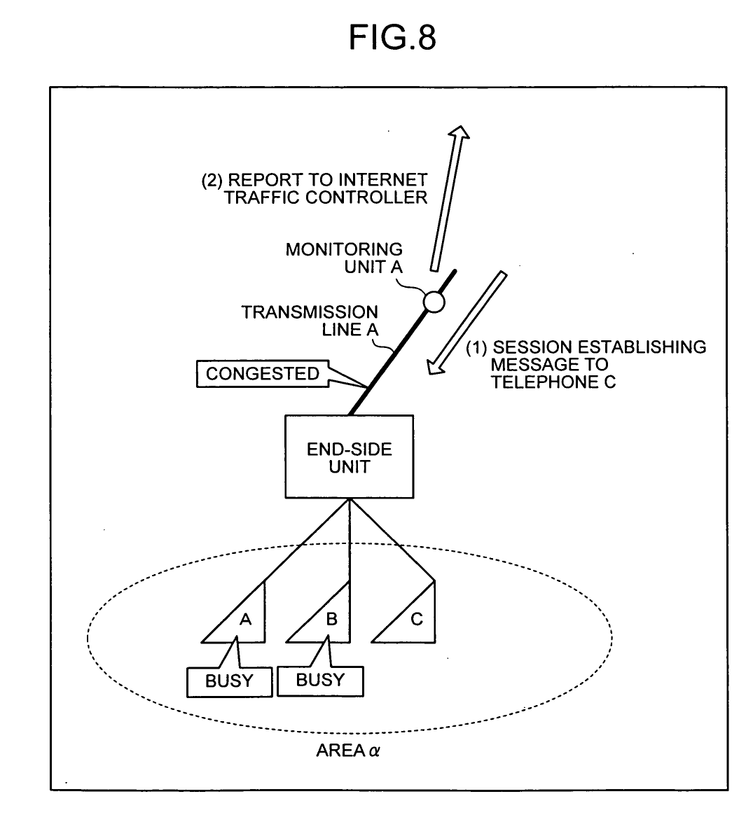

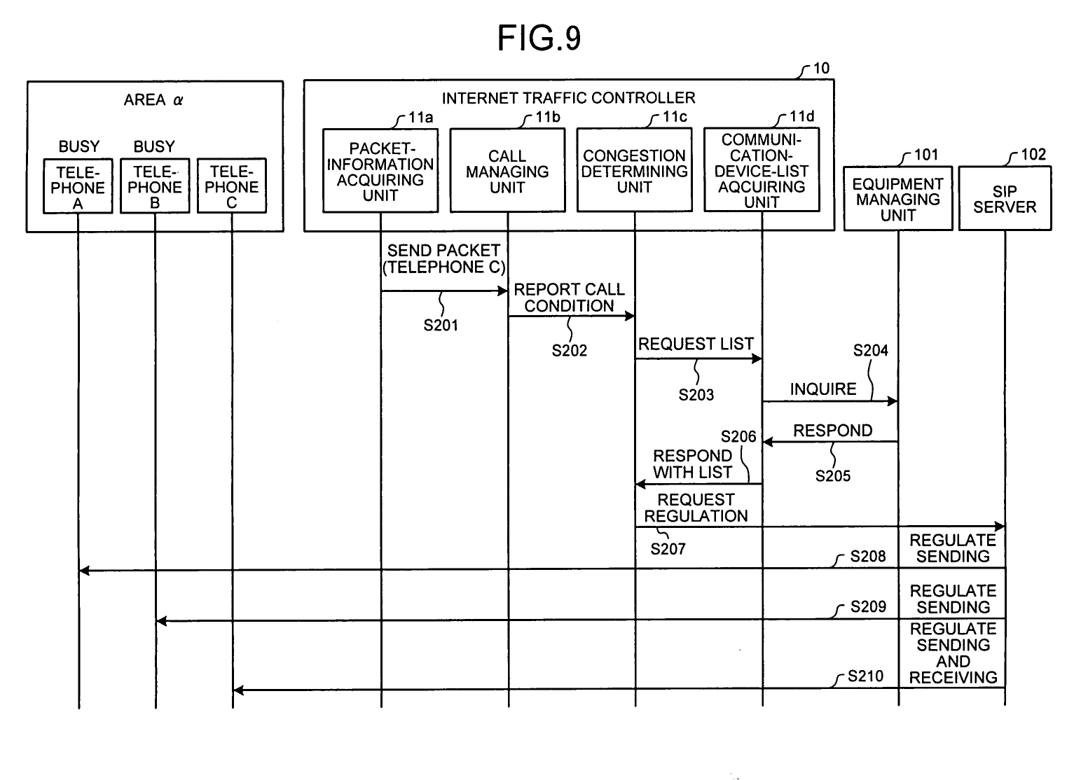

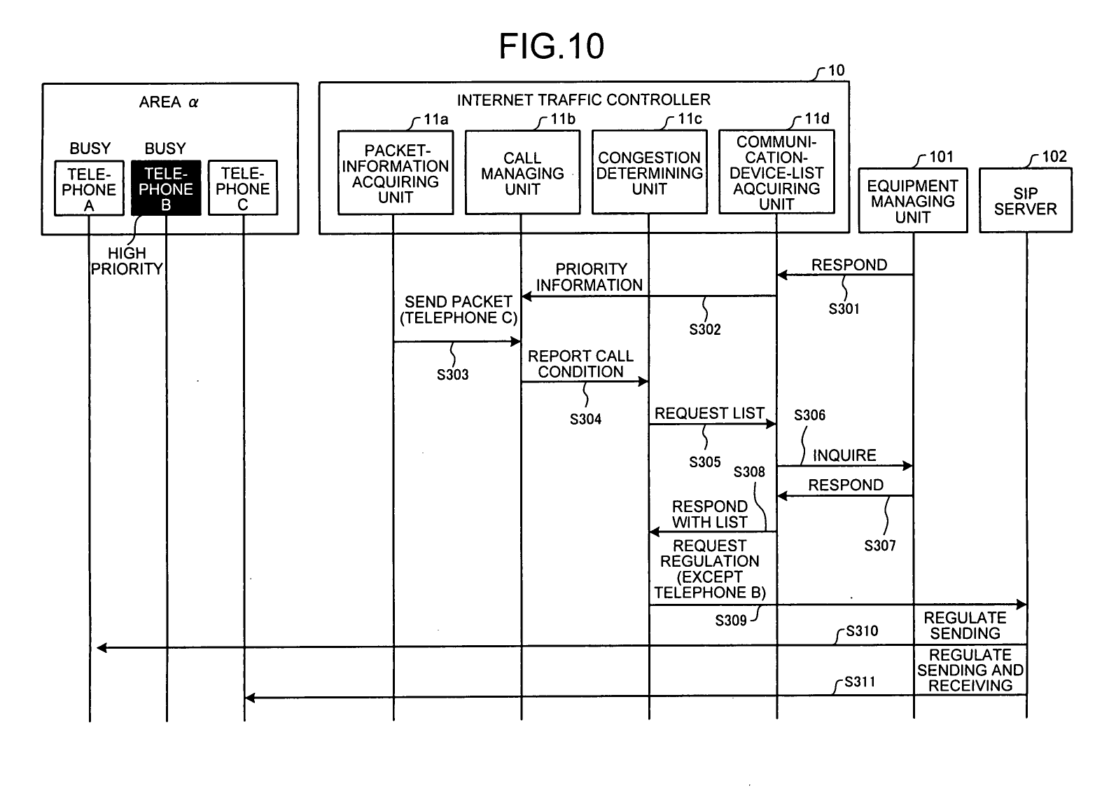

FIG. 8 is an example of a situation where a call is made; FIG. 9 is a sequence diagram for explaining a process under the condition of the call shown in FIG. 8; and FIG. 10 is a sequence diagram for explaining the process based on the priority. The sequence diagram shown in FIG. 9 uses the list of the communication devices shown in FIG. 7A, and the sequence diagram shown in FIG. 10 uses the list of the communication devices shown in FIG. 7B.

As shown in FIG. 8, it is assumed that the transmission line A includes telephones A, B, and C via the end-side unit; the telephones belong to the area α; and the telephones A and B are busy, which are congesting the transmission line A. In this case, when someone calls the telephone C, the session establishing message to the telephone C is transmitted through the transmission line A (see (1) in FIG. 8). The monitoring unit A reports the session establishing message to the internet traffic controller (see (2) in FIG. 8). The explanation is given with reference to the sequence diagrams in FIGS. 9 and 10 based on the condition shown in FIG. 8.

As shown in FIG. 9, upon receiving the session establishing message from the monitoring unit 103, the packet-information acquiring unit 11a sends the session establishing message to the call managing unit 11b (step S201). The call managing unit 11b then reports the condition of the call to the congestion determining unit 11c by referencing the call managing information 12a in the storage unit 12 (step S202). The congestion determining unit 11c requests the communication-device-list acquiring unit 11d to acquire the list of the telephones belonging to the corresponding transmission line (step S203). Upon receiving the request, the communication-device-list acquiring unit 11d inquires the equipment managing unit 101 for the list of the communication devices (step S204), and returns the received response (step S205) to the congestion determining unit 11c as the list response (step S206).

The congestion determining unit 11c then requests the SIP server 102 to regulate the calls via the congestion-control instructing unit 11e (step S207). Upon receiving the request for the regulation, the SIP server 102 regulates sending by the telephones A and B (steps S208 and S209), and regulates sending and receiving by the telephone C (step S210).

In FIG. 10, it is assumed that the communication-device-list acquiring unit 11d has already requested the priority information from the equipment managing unit 101.

When the equipment managing unit 101 responds to the communication-device-list acquiring unit 11d (step S301), the communication-device-list acquiring unit 11d reports the priority information included in the response to the call managing unit 11b (step S302). Upon receiving the session establishing message to the telephone C, the packet-information acquiring unit 11a sends the call control packet to the call managing unit 11b (step S303).

After adding the priority information, the call managing unit 11b reports the condition of the call to the congestion determining unit 11c (step S304). The congestion determining unit 11c then requests the communication-device-list acquiring unit 11d to acquire the list of the telephones belonging to the corresponding transmission line (step S305). The communication-device-list acquiring unit 11d inquires the equipment managing unit 101 for the list of the communication device (step S306), and returns the received response (step S307) to the congestion determining unit 11c as the list response (step S308).

The congestion determining unit 11c then requests the SIP server 102 to regulate the calls via the congestion-control instructing unit 11e (step S309). Because it is evident from the priority information that the telephone B is prioritized and the bandwidth to be used by the telephone B is already saved, the congestion determining unit 11c should request the regulation for the telephones A and C. Upon receiving the request for the regulation, the SIP server 102 regulates sending by the telephone A (step S310), and regulates sending and receiving by the telephone C (step S311).

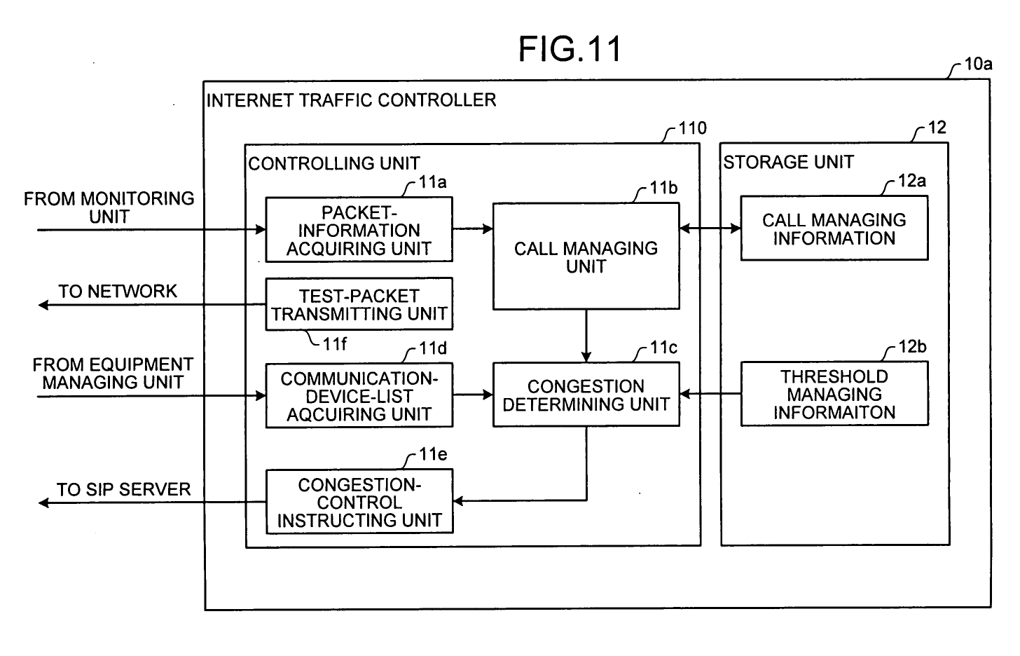

FIG. 11 is a detailed block diagram of an internet traffic controller 10a according to a second embodiment of the present invention. The internet traffic controller 10a can be used instead of the internet traffic controller 10 in the network shown in FIG. 1. In FIG. 11, each of the units common with FIG. 2 has the reference numeral common with FIG. 2. Differences from the internet traffic controller 10 shown in FIG. 2 are explained, and common features are omitted below.

The internet traffic controller 10a includes a controlling unit 110 that includes a test-packet transmitting unit 11f in addition to all the units of the controlling unit 11 of the internet traffic controller 10. The test-packet transmitting unit 11f transmits a test packet (a virtual call packet (RTP packet)) to a transmission line of which the congested condition is not clear. Upon receiving the test packet, the monitoring unit 103 reports the test packet to the internet traffic controller 10a, and the call managing unit 11b determines whether the corresponding transmission line is congested based on the loss and the delay of the test packet.

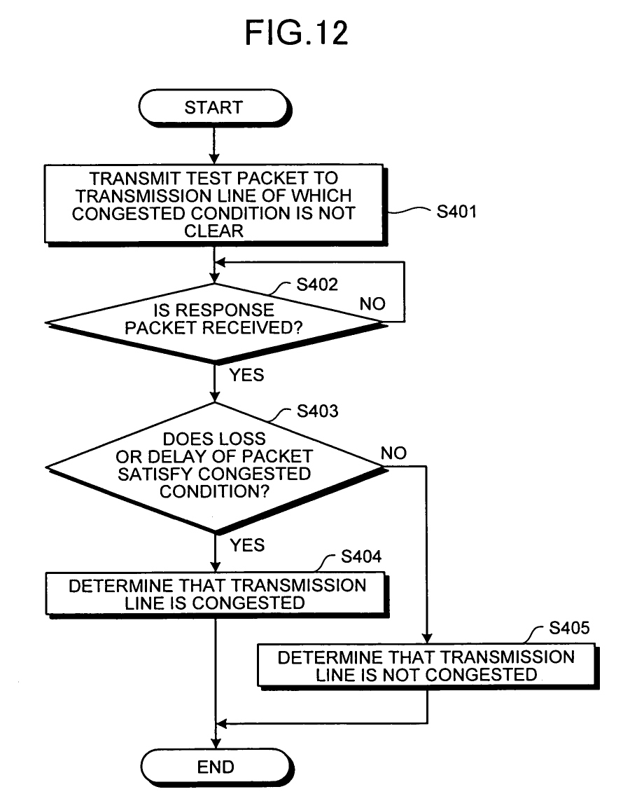

FIG. 12 is a flowchart for explaining a process performed by the internet traffic controller 10a. The test-packet transmitting unit 11f transmits the test packet to the transmission line of which the congested condition is not clear (step S401). The packet-information acquiring unit 11a waits for a response packet to the test packet (NO at step S402). When the packet-information acquiring unit 11a receives the response packet (YES at step S402), it is determined whether the loss or the delay of the packet satisfies a predetermined congested condition (step S403).

When the congested condition is satisfied (YES at step S403), the transmission line is determined to be congested (step S404), and the process is terminated. When the congested condition is not satisfied (NO at step S403), the transmission line is determined to be not congested (step S405), and the process is terminated.

According to an aspect of the present invention, in this manner, call control packets and call packets flowing in a transmission line are acquired, and whether the transmission line is congested is determined based on number or contents of the acquired packets. Moreover, if a transmission line is determined to be congested, the SIP server stops the traffic in that transmission line. As a result, it is possible to accurately estimate the number of the call connections, and take measures to avoid congestion of telephone calls in IP networks.

According to another aspect, a test packet that imitates the call packet is transmitted to a predetermined transmission line, and it is determined whether the transmission line is congested based on the call packets including the test packet. By transmitting the test packet to a transmission line of which the congested condition is not clear, it is possible to know whether the transmission line is congested.

According to still another aspect, general packets are further acquired and the congestion of the transmission line is determined based on the call control packets, the call packets, and the general packets. This makes it possible to determine the congested condition of the transmission line correctly by acquiring the correct bandwidth available for the telephone call, even when the bandwidth for the telephone call is actually narrowed due to the general packets.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An internet traffic controller that controls internet traffic in an internet protocol network through which packets are distributed for telephone calls between a first communication device and a second communication device, the internet traffic controller comprising:
a packet acquiring unit that acquires call control packets and call packets flowing on a transmission line between the first communication device and the second communication device on the internet protocol network;
a congestion determining unit that determines whether the transmission line is congested based on the call control packets and the call packets acquired by the packet acquiring unit; and
an instructing unit that instructs regulation of call connections over the transmission line when the congestion determining unit determines that the transmission line is congested.

2. The internet traffic controller according to claim 1, further comprising a test-packet transmitting unit that transmits a test packet over the transmission line,
wherein the congestion determining unit determines whether the transmission line is congested based on the call packets including the test packet transmitted from the test-packet transmitting unit.

3. The internet traffic controller according to claim 1, wherein
the packet acquiring unit acquires general packets flowing on the transmission line, and
the congestion determining unit determines whether the transmission line is congested based on the call control packets, the call packets, and the general packets.

4. The internet traffic controller according to claim 1, further comprising a communication-device-list acquiring unit that acquires a list of communication devices that receive packets via the transmission line, wherein
the instructing unit instructs regulation of the call connections over the transmission line based on the list acquired by the communication-device-list acquiring unit when the congestion determining unit determines that the transmission line is congested.

5. The internet traffic controller according to claim 4, wherein
the list includes a priority level of each communication device that receives packets via the transmission line, and
the instructing unit instructs regulation of the call connections over the transmission line based on the priority level.

6. The internet traffic controller according to claim 1, wherein the congestion determining unit determines whether the transmission line is congested based on a call condition estimated from the call control packets and amount of the call packets related to the call control packets.

7. An internet-traffic controlling system that controls internet traffic in an internet protocol network through which packets are distributed for telephone calls between a first communication device and a second communication device, the internet-traffic controlling system comprising:
a packet acquiring unit that acquires call control packets and call packets flowing on a transmission line between the first communication device and the second communication device on the internet protocol network;
a congestion determining unit that determines whether the transmission line is congested based on the call control packets and the call packets acquired by the packet acquiring unit; and
an instructing unit that instructs regulation of call connections over the transmission line when the congestion determining unit determines that the transmission line is congested.

8. The internet-traffic controlling system according to claim 7, further comprising a test-packet transmitting unit that transmits a test packet over the transmission line,
wherein the congestion determining unit determines whether the transmission line is congested based on the call packets including the test packet transmitted from the test-packet transmitting unit.

9. An internet-traffic controlling method of controlling internet traffic in an internet protocol network through which packets are distributed for telephone calls between a first communication device and a second communication device, the internet-traffic controlling method comprising:
acquiring call control packets and call packets flowing on a transmission line between the first communication device and the second communication device on the internet protocol network;
determining whether the transmission line is congested based on the call control packets and the call packets acquired at the acquiring; and
instructing regulation of call connections over the transmission line upon it is determined at the determining that the transmission line is congested.

10. The internet traffic controlling system according to claim 9, further comprising transmitting a test packet over the transmission line,
wherein the determining includes determining whether the transmission line is congested based on the call packets including the test packet transmitted at the transmitting.
